(19) United States
(12) Patent Application Publication
(10) Pub. No.: US 2008/0162966 A1
(43) Pub. Date: Jul. 3, 2008

(54) SYSTEM AND METHOD FOR HANDLING ACCESS TO MEMORY MODULES

(75) Inventors: David J. Krause, Kenosha, WI (US); Joshua D. Galicia, Cary, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/617,022

(22) Filed: Dec. 28, 2006

(51) Int. Cl. G06F 1/08

(52) U.S. Cl. 713/322

(57) ABSTRACT

A method includes the provision of a list, which identifies a condition of at least one memory module. Attempted access to the at least one memory module is identified. The list is utilized to determine whether or not the at least one memory module is in a first condition. An exception is generated when the at least one memory module is in the first condition. A system includes: a list processing module, configured to identify a condition of the at least one memory module; an access identifying module, configured to identify access to the at least one memory module; a list controlling module, configured to determine whether or not the at least one memory module is in a first condition; and an exception generating module, configured to generate an exception when the at least one memory module is in the first condition.

### FIELD

The present application relates generally to handling access to memory modules and more particularly to power management systems.

### BACKGROUND

In highly integrated system-on-chip devices, there are numerous blocks in addition to a processor. These blocks contain memory modules which are disabled when they are not in use. The blocks are disabled by disabling the high speed clocks to the memory modules. This technique helps to save power when used on a device which is battery operated. In particular this method is used on mobile phones to save the battery life.

However, it is not always clear in an arbitrary piece of software that the clock is disabled at the time the access to the blocks happens, and it is difficult to make sure that every access to the memory modules have sufficient checking for the clocks being enabled. If the memory modules are accessed when the clocks are disabled, the access fails and the device may power down, reset, or enter an unknown state.

Accordingly, an improved method for handling access to the memory modules is needed.

### BRIEF DISCRIPTION OF THE DRAWINGS

For the purpose of facilitating an understanding of the subject matter sought to be protected, there are illustrative embodiments in the accompanying drawing, from an inspection of which, when considered in connection with the following description and claims, the subject matter sought to be protected, its construction and operation, and many of its advantages should be readily understood and appreciated.

FIG. 1 is an exemplary block diagram comprising a plurality of exemplary modules depicting a system for handling access to a memory module.

FIG. 2 is an exemplary block diagram of an enabling module of FIG. 1.

FIG. 3 is an exemplary block diagram of an exception generating module of FIG. 1.

FIG. 4 is an exemplary block diagram of a list controlling module of FIG. 1.

FIG. 5 is a flow diagram depicting an exemplary method for handling access to a memory module.

FIG. 6 is a flow diagram depicting an exemplary method for enabling a memory module.

### DETAILED DESCRIPTION

In one example, a method is provided. A list is provided to identify a condition of at least one memory module. An attempted access is identified to the at least one memory module. The list is utilized to determine whether or not the memory module is in a first condition. An exception is generated when the at least one memory module is in the first condition.

In one example, a system is provided. The system includes at least one memory module. A list processing module is configured to identify a condition of the at least one memory module. An access identifying module is configured to identify access to the at least one memory module. A list controlling module is configured to determine whether or not the at least one memory module is in a first condition. An exception generating module is configured to generate an exception when the at least one memory module is in the first condition.

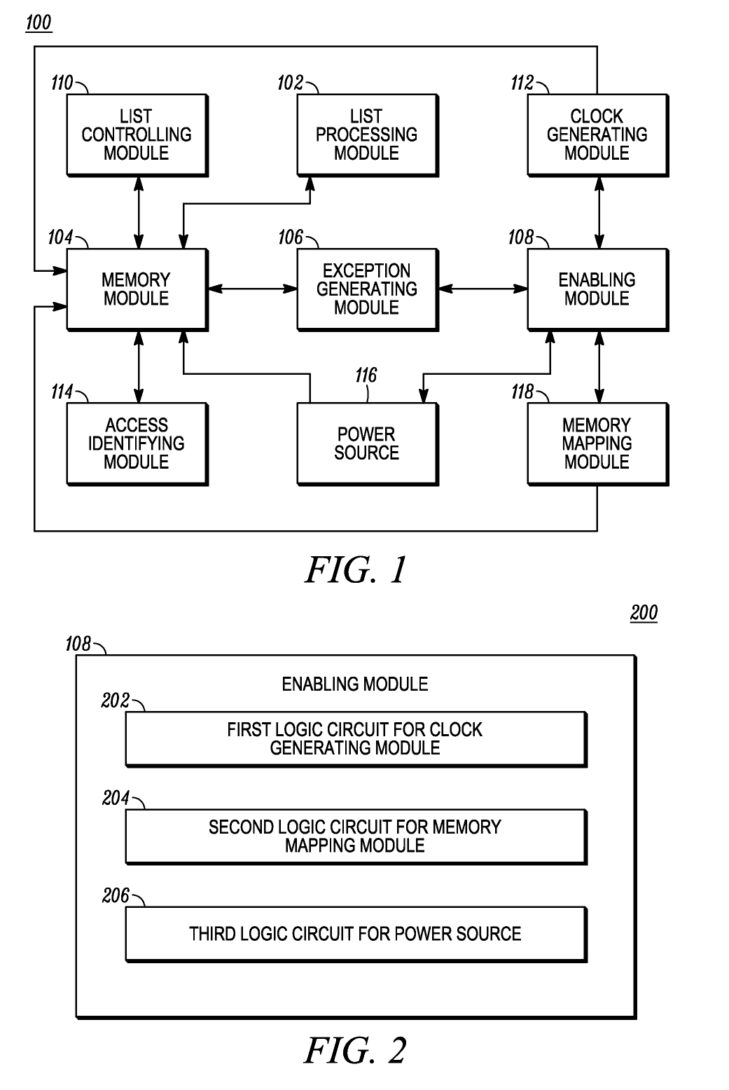

Referring to FIG. 1, a block diagram depicting a system 100, which includes an exception generating module 106, an enabling module 108 and a list controlling module 110. FIG. 1 also includes a memory module 104, a list processing module 102 and an access identifying module 114. The enabling module 108 is coupled to a clock generating module 112, a power source 116 and a memory mapping module 118. The terms used have been chosen as useful to describe the functionality herein.

In one example, the system 100 is embodied in a portable communication device in which the memory module 104 is a register. In one example, the register is disabled when not in use for saving battery power. However, a person with an ordinary skill the art would realize that there could be more than one register for the memory module 104. Examples of portable communication device include, but are not limited to, cellular phones, mobile phones, pagers, radios, personal digital assistants (PDAs), mobile data terminals, application specific gaming device, video gaming device incorporating wireless modems, and combinations or sub combinations of these devices. The design and operation of these devices is well known, so a detailed description of each possibility will be omitted. In one example, the system 100 is embodied on a mobile phone in a wireless communication system. Examples of wireless communication system include, but are not limited to, GSM, GPRS, WiFi (802.11), WiMax (806.16e) and Bluetooth.

In one example, the system 100 is embodied in a processor. Examples of processor include, but are not limited to, application-specific integrated circuits (ASICs), digital signal processor (DSPs), Microprocessor (8085, 8086) or other suitable specific or general purpose processor.

In one example, the memory module 104 is bi-directionally coupled to the list processing module 102, the list controlling module 110, the access identifying module 114, and the exception generating module 106. In this example, the memory module 104 is also coupled to the power source 116, the memory mapping module 118, and the clock generating module 112. In one example, the memory module 104 may be a random access memory (RAM) module, a read only memory (ROM) module, a magnetic storage, an optical storage or any other data storage module in which data, instructions, software routines, code sets, databases, etc. can be stored.

In one example, the memory module 104 includes a database. In one example, this database stores an identity of each of the module in the system 100. Examples of database include, but are not limited to, stack—last in first out (LIFO), queue—first in first out (FIFO), or collection of records stored in software related system in a systematic way. In another example, an executable coded software or program can consult or refer to the database to answer questions, make decisions and to manage and query a database management system. In another example, the memory module 104 when disabled contains a null value. In this example, the null value means that the memory module 104 may not have any data stored in it. In some examples, the memory module 104 when disabled will contain some data or value however it would not be accessible by any module or device.

In one example, the list processing module 102 is coupled bi-directionally to the memory module 104. In one example, the list processing module 102 is configured to identify a condition of the memory module 104. Examples of the condition of the memory module 104 include, but are not limited to, unstable, inaccessible, disabled, and enabled. In one example, the list processing module 102 processes a database stored in the memory module 104.

In one example, the access identifying module 114 is coupled bi-directionally to the memory module 104. In one example, the access identifying module 114 is configured to identify an attempted access to the memory module 104. In another example, the attempted access could be made by an external module or an internal module. Examples of external module include, but are not limited to, Universal Serial Bus (USB), Infrared, Bluetooth or any other similar device. Example of internal module may be any module on the system which tries to access the memory module 104.

In one example, the list controlling module 110 is coupled bi-directionally to the memory module 104. In one example, the list controlling module 110 is configured to determine whether or not the memory module 104 is in a first condition. In this example, the first condition is referred to as the memory module 104 to be disabled. In another example, the list controlling module 110 controls a database stored in the memory module 104.

In one example, the exception generating module 106 is coupled bi-directionally to the enabling module 108 and the memory module 104. In one example, the exception generating module 106 generates an exception when the memory module 104 is accessed, while the memory module 104 is disabled. In one example, the exception generating module 106 is configured to identify a mode of a mobile phone. Examples of mode include, but are not limited to, factory mode, customer mode, user mode, and any other such mobile based mode. In one example, the exception generating module 106 is a software based code which is executed whenever initiated by the system 100. Examples of exception include, but are not limited to, out of range error, memory location disabled or any other type of software error based exceptions.

In one example, the enabling module 108 is coupled bi-directionally to the clock generating module 112, the power source 116, and the memory mapping module 118. In one example, the enabling module 108 enables the memory module 104 when an access is attempted to the memory module 104 while the memory module 104 is in a first condition. In one example, the memory mapping module 118 maps the memory module to an addressable memory. In one example, mapping to an addressable memory includes storing data in the memory module 104.

Referring to FIG. 2, a descriptive block diagram of an enabling module 108 is shown for illustrative purposes. In this example, the enabling module 108 includes a first logic circuit for clock generating module 202, a second logic circuit for memory mapping module 204, and a third logic circuit for power source 206. In one example, these three logic circuits generate enable signals for the clock generating module 112, the power source 116, and the memory mapping module 118. In one example, the three logic circuits generate the signals in 0's and 1's, whereby “0” represents a disable signal and “1” represents an enable signal. In one example, the logic circuit is replaced by a switch where an “ON” signal identifies an enable signal and “OFF” signal identifies a disable signal. In another example, the three logic circuits may be replaced by three clocks.

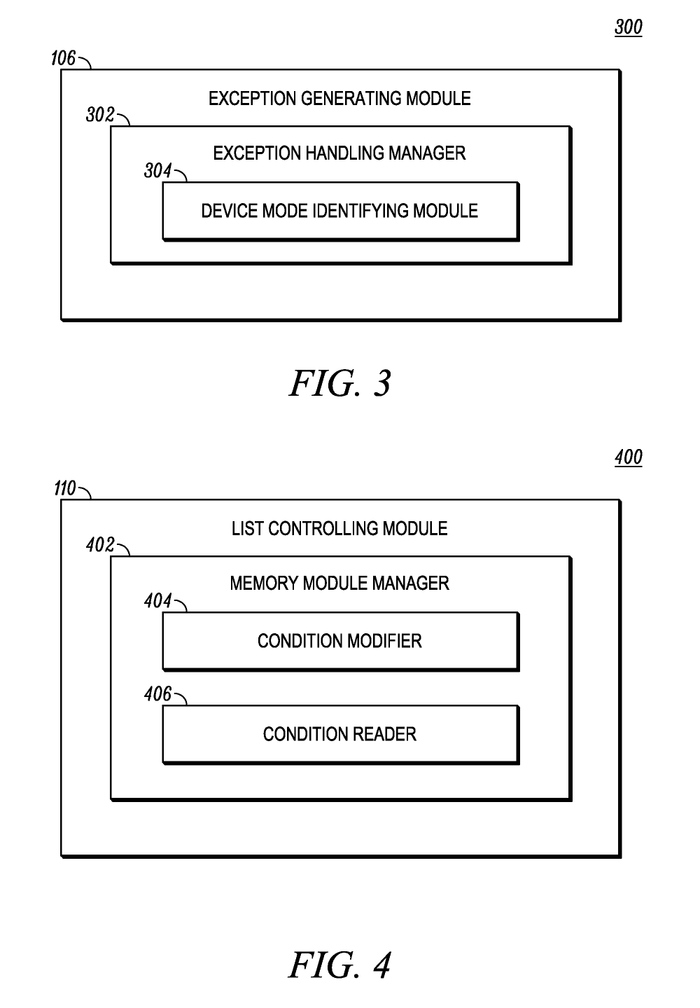

Referring now to FIG. 3, a descriptive block diagram of an exception generating module 106 is shown for illustrative purposes. In this example, the exception generating module 106 includes an exception handling manager 302 and a device mode identifying module 304. In one example, the device mode identifying module 304 is configured to determine whether or not a portable communication device is in a user mode. In another example, the device mode identifying module 304 is configured to log a fatal error if the portable communication device is not in a user mode. Examples of fatal error include, but are not limited to, “Ox” error messages, unsupported operand types, Error 1603, and other such software based fatal error. In one example, the exception handling manager 302 is capable of performing all exception related tasks.

Referring to FIG. 4, a descriptive block diagram of a list controlling module 110 is shown for illustrative purposes. In the example, the list controlling module 110 includes a memory module manager 402. In this example, the memory module manager 402 further includes a condition modifier 404 and a condition reader 406. In one example, the condition reader 406 is configured to determine whether the memory module 104 is in an enabled condition or a disabled condition.

In one example, the condition modifier 404 is configured to change the condition of the memory module 104 from a first condition to a second condition. In one example, the first condition relates to the memory module 104 being disabled and the second condition relates to the memory module 104 being enabled. However, a person with an ordinary skill in the art would realize that a memory module 104 may have different types of conditions.

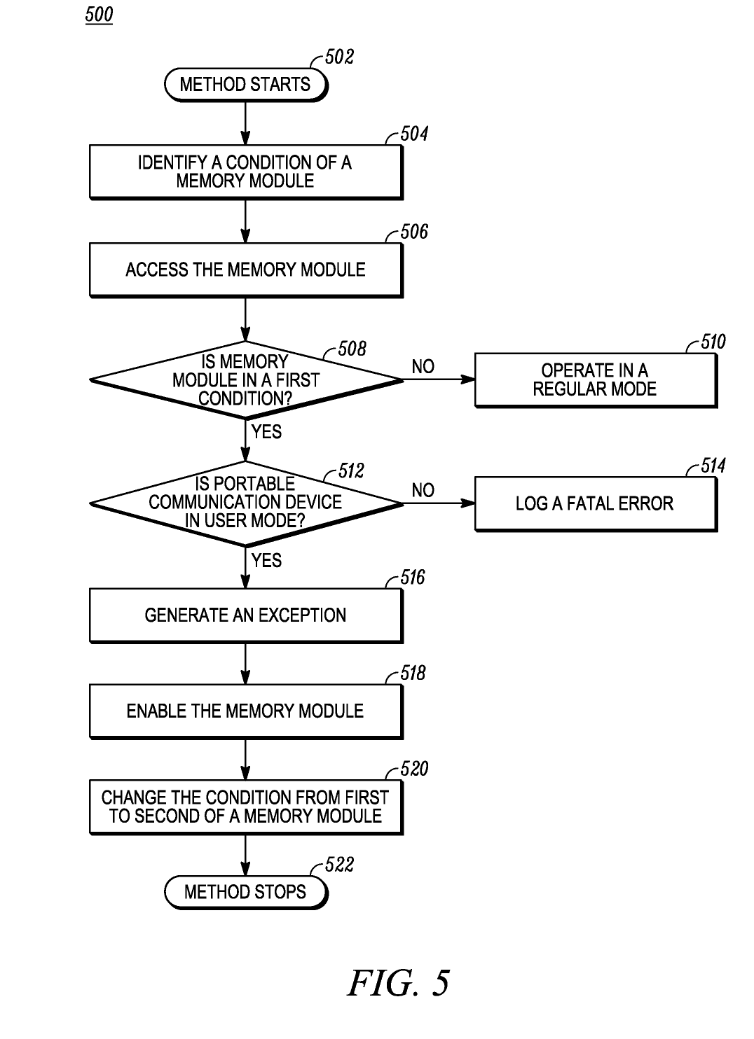

Referring to FIG. 5, a flow diagram depicting a method implied in the system 100 will now be described for illustrative purposes. In step 504, the condition of the memory module is identified. In one example, a condition reader (e.g. 406) identifies the condition of the memory module. Examples of condition include, but are not limited to, stable, unstable, semi-stable, inaccessible, enabled, disabled and other similar conditions, as also mentioned earlier. In step 506, the memory module is accessed. In one example, an access identifying module (e.g. 114) is configured to identify access to the memory module. In this example, the memory module is embodied in a portable communication device, whereby the access may be attempted by an Infrared port, a USB port, a Bluetooth port and similar external devices.

In step 508, the decision is taken whether the memory module is in a first condition or not. If the memory module is in a first condition, step 512 is executed otherwise step 510 is executed. In one example, the first condition of the memory module identifies the memory module being disabled, as discussed earlier. However, a person with ordinary skill in the art would realize that step 508 may be performed to identify any type of condition of the memory module. In step 510, the portable communication device will operate in a regular mode. In one example, the regular mode refers to normal functioning of the portable communication device.

In step 512, the decision is taken whether the portable communication device is in a user mode or not. If the portable communication device is in a user mode, step 516 is executed otherwise step 514 is executed. In one example, a user mode is when the portable communication device is with the user and not in the factory. In one example, the device mode identifying module (e.g. 304) identifies whether the portable communication device is in a user mode.

In step 514, a fatal error is logged. In one example, device mode identifying module logs the fatal error. However, a person with ordinary skill in the art would realize that a fatal error may be logged for any mode depending upon the requirement of a system (e.g. 100). In step 516, an exception is generated after it is identified that the portable communication device is in the user mode. In one example, an exception generating module (e.g. 106) may generate the exception. After the exception is generated, the memory module is enabled in step 518. In one example, an enabling module (e.g. 108) enables the memory module. In step 520, the condition of a memory module is changed from a first condition to a second condition. In one example, a condition modifier (e.g. 404) changes the first condition to the second condition.

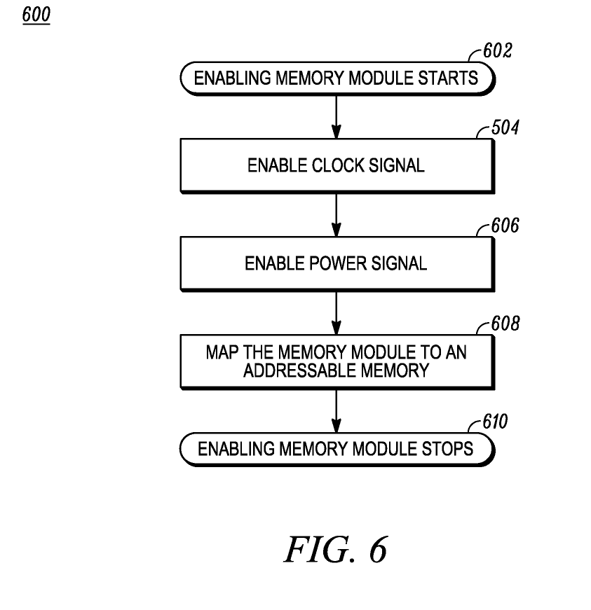

Referring now to FIG. 6, a flow diagram depicts a method for enabling a memory module (e.g. step 518). In step 604, a clock signal to the memory module is enabled. In step 608, a power signal to the memory module is enabled and in step 608, the memory module is mapped to an addressable memory.

In one example, an enabling module (e.g. 108) is used for generating an enable signal. In one example, three logic circuits (e.g. 200) are used for generating enable signals for a power source (e.g. 116), a memory mapping module (e.g. 118) and a clock generating module (e.g. 112).

While particular embodiments have been shown and described, it will be apparent to those skilled in the art that changes and modifications may be made without departing from the principles set forth herein. The matter set forth in the foregoing description and accompanying drawings is offered by way of illustration only and not as a limitation.

We claim:

1. A method, comprising the steps of:
providing a list, which identifies a condition of at least one memory module;
identifying attempted access to the at least one memory module;
utilizing the list to determine whether or not the at least one memory module is in a first condition; and
generating an exception when the at least one memory module is in the first condition.

2. The method as claimed in claim 1 wherein the method is embodied in a portable communication device in a wireless communication system.

3. The method as claimed in claim 1 wherein the step of determining whether or not the at least one memory module is in the first condition comprises determining whether the at least one memory module is disabled.

4. The method as claimed in claim 1 further comprising operating in a regular mode if the at least one memory module is not in the first condition.

5. The method as claimed in claim 2 further comprising determining a mode of the portable communication device if the at least one memory module is in the first condition.

6. The method as claimed in claim 5 further comprising logging a fatal error if the at least one memory module is not in a user mode.

7. The method as claimed in claim 1 further comprising enabling the at least one memory module after generating the exception.

8. The method as claimed in claim 7 further comprising:
enabling a clock signal to the at least one memory module;
mapping the at least one memory module to an addressable memory so that the at least one memory module becomes accessible;
enabling a power signal to the at least one memory module; and
changing the condition of the at least one memory module to a second condition.

9. The method as claimed in claim 8 wherein the second condition identifies that the at least one memory module is enabled.

10. The method as claimed in claim 9 further comprising updating the list wherein the list identifies that the at least one memory module is enabled.

11. The method of claim 1, further comprising:
disabling a clock signal to the at least one memory module;
unmapping the at least one memory module from an addressable memory so that the at least one memory module becomes inaccessible;
disabling a power signal to the at least one memory module; and
updating the list to identify that that at least one memory module is disabled.

12. A system, comprising:
at least one memory module;
a list processing module, configured to identify a condition of the at least one memory module;
an access identifying module, configured to identify access to the at least one memory module;
a list controlling module, configured to determine whether or not the at least one memory module is in a first condition; and
an exception generating module, configured to generate an exception when the at least one memory module is in the first condition.

13. The system as claimed in claim 12 wherein the system is embodied in a portable communication device in a wireless communication system.

14. The system as claimed in claim 12 wherein the list controlling module is further coupled with a memory module manager which further comprises a condition modifier and a condition reader.

15. The system as claimed in claim 14 wherein the condition reader is further configured to determine that the at least one memory module is disabled.

16. The system as claimed in claim in 12 wherein the exception generating module further comprises an exception handling manager and a device mode identifying module.

17. The system as claimed in claim 16 wherein the device mode identifying module is configured to determine whether or not a portable communication device is in a user mode.

18. The system as claimed in claim 17 wherein the device mode identifying module is further configured to log a fatal error if the portable communication device is not in the user mode.

19. The system as claimed in claim 12 further comprises an enabling module is configured to enable the at least one memory module.

20. The system as claimed in claim 19 wherein the enabling module further comprises:
a first logic circuit coupled to a clock generating module which enables the clock generating module to generate a clock signal to the at least one memory module;
a second logic circuit coupled to a memory mapping module which enables the memory mapping module to map the at least one memory module; and
a third logic circuit coupled to a power source which enables the power source to the at least one memory module.
